(19) United States
(12) Patent Application Publication
(10) Pub. No.: US 2004/0079210 A1
(43) Pub. Date: Apr. 29, 2004

(54) Log-processing machine having a pivot system

(76) Inventors: Joseph Andre Pascal Robitaille, Abitibi (CA); Robert Martin Rousseau, Abitibi (CA)

Correspondence Address: Stephan P. Georgiev, SMART & BIGGAR, Suite 3400, 1000 de La Gauchetiere West, Montreal, QC, H3B 4W5, CA

(21) Appl. No.: 10/278,796

(22) Filed: Oct. 24, 2002

(51) Int. Cl. B26D 5/20; B26D 7/06; B26D 5/00

(52) U.S. Cl. 83/76.8; 83/113; 83/368

(57) ABSTRACT

The present invention relates to a log-processing machine that includes a frame and at least one cutting head that is movable in relation to the frame along a path of travel. The path of travel includes a horizontal displacement component and a vertical displacement component and defines a plurality of log engaging positions. For example, the at least one cutting heads are movably mounted to the frame via at least one pivot, whereby the path of travel is defined by the cutting head's movement about the pivot. The log-processing machine is adapted to receive end loaded logs, such that when the at least one cutting head is in engagement with a log, a relative movement between the log and the cutting heads in a longitudinal direction of the log causes the cutting heads to cut away a side of the log.

### FIELD OF THE INVENTION

The present invention relates to a log-processing machine. More particularly, the present invention relates to a log-processing machine having a frame and at least one cutting head that is mounted to the frame via at least one pivot.

### BACKGROUND OF THE INVENTION

Log-processing machines suitable for cutting the longitudinal sides of a log are well known in the art of lumber manufacturing. Traditionally, such log-processing machines include a frame and at least one cutting head that is movably mounted to the frame such that it can move into a plurality of log-engaging positions. Therefore, when the cutting head is in a specific log-engaging position, a relative movement of the log and the cutting head in a direction along the longitudinal axis of the log causes the cutting head to cut away at least a portion of the side of the log.

In order to adjust the log-engaging position of a cutting head, the cutting head is typically mounted to the frame of the log-processing machine via a forwards and backwards sliding mechanism. More specifically, the cutting head is mounted on a base that is able to slide backwards and forwards along a track in the frame. As such, depending on the size of the log to be processed, and the depth of cut desired, the cutting head can be slid into a selected log-engaging position.

A deficiency with log-processing machines such as the one described above that use a forwards and backwards sliding mechanism to adjust the positioning of their cutting heads, is that they require a lot of oiling in order to slide smoothly. This requires significant maintenance and care, and can be messy for the operator. In addition, the play in the sliding track that enables the cutting heads to move smoothly back and forth has the detrimental effect that it causes the cutting heads to vibrate during use. This vibration reduces the quality of the surface finish of the cut log, and also creates low-quality wood chips.

A still further deficiency with the sliding mechanism described above is that it only enables the position of the cutting heads to be adjusted in one direction, namely in the horizontal direction. As such, the height of the cutting heads cannot be adjusted depending on the size of the logs, which means that the logs are not always properly positioned in relation to the cutting heads. This ultimately results in low-quality surface finish on the log.

Therefore, in the context of the above, it is apparent that there is a need in the industry for a log processing machine that alleviates at least in part the problems associated with the existing log-processing machines.

### SUMMARY OF THE INVENTION

In a first broad aspect, the present invention provides a log-processing machine that includes a frame and at least one cutting head that is mounted to the frame via at least one pivot. The cutting head is movable about the pivot such that it can move towards and away from a log. As such, when the cutting head engages the log, a relative movement between the log and the cutting head in a longitudinal direction of the log causes the cutting head to cut away a side of the log at least along a portion of the length of the log.

In accordance with a specific example of implementation of the present invention, the cutting head is movable about the pivot between a plurality of log-engaging positions.

### BRIEF DESCRIPTION OF THE DRAWINGS

A detailed description of examples of implementation of the present invention are provided hereinbelow with reference to the following drawings, in which:

FIG. 1 shows a top perspective view of a log-processing machine in accordance with a specific example of implementation of the present invention;

FIG. 2 shows a top plan view of the log-processing machine of FIG. 1, with a log being processed shown therein;

FIG. 3a shows a first side elevation view of the log-processing device of FIG. 1, with the cutting heads shown in a position for receiving logs having a small diameter;

FIG. 3b shows a second side elevation of the log-processing device of FIG. 1, with the cutting heads shown in a position for receiving logs having a large diameter;

FIG. 4a shows a small log positioned between two cutting heads of a prior art log-processing machine;

FIG. 4b shows a large log positioned between two cutting heads of a prior art log-processing machine;

FIG. 5a shows a small log positioned between two cutting heads of the log-processing machine shown in FIG. 1;

FIG. 5b shows a large log positioned between two cutting heads of the log-processing machine shown in FIG. 1.

In the drawings, embodiments of the invention are illustrated by way of example. It is to be expressly understood that the description and drawings are only for the purposes of illustration and as an aid to understanding, and are not intended to be a definition of the limits of the invention.

### DETAILED DESCRIPTION

The detailed description below refers to a log-processing machine for processing logs in order to make pieces of lumber.

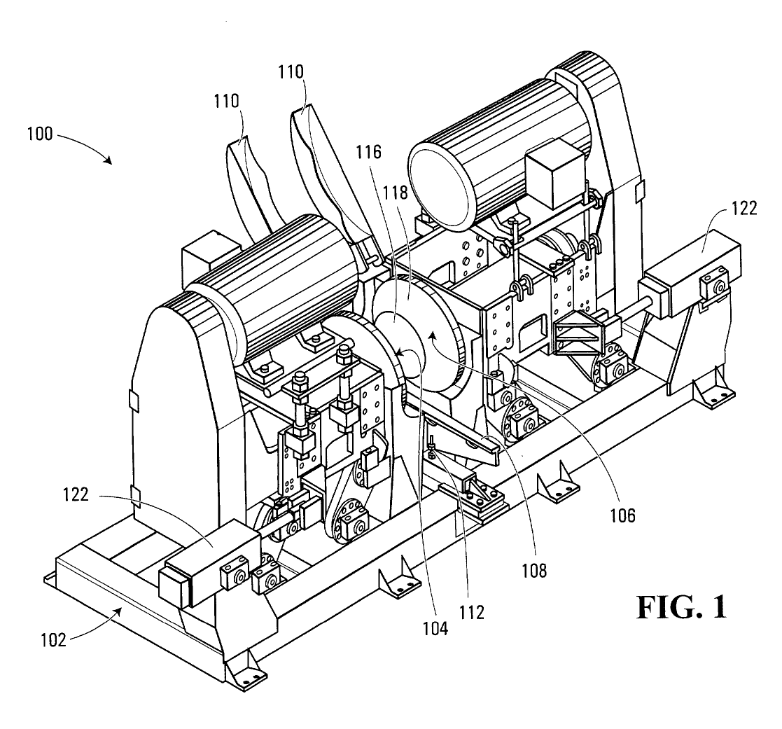

Shown in FIG. 1 is a log-processing machine 100 in accordance with a specific example of implementation of the present invention. The log-processing machine 100 includes a frame 102, a first cutting head 104, a second cutting head 106 and a log-supporting device 108. First cutting head 104 and second cutting head 106 are both movably mounted to frame 102 so as to be able to move along a path of travel towards and away from a log to be processed.

During operation, the first and second cutting heads 104 and 106 are covered by protective shields 110, which are hingedly connected to a portion of frame 102. FIG. 1 shows protective shields 110 in an open position in order to provide a better view of the first and second cutting heads 104, 106.

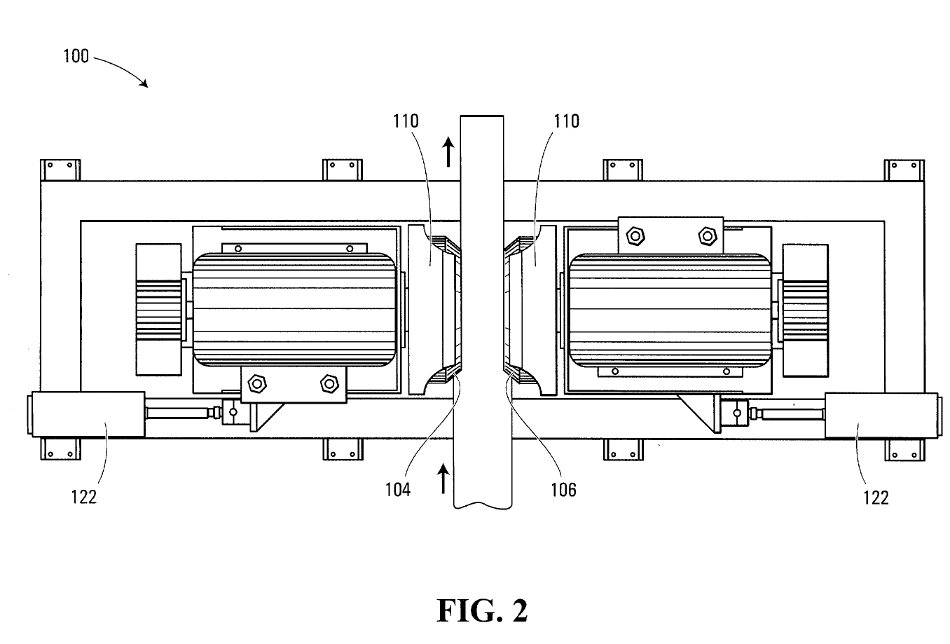

As shown in FIG. 2, log-processing machine 100 is adapted to receive end-loaded logs between the first cutting head 104 and the second cutting head 106, which are movable between a plurality of log-engaging positions along respective paths of travel in order to be able to process logs having different diameters. In operation, when the first and second cutting heads 104, 106 are in a selected log-engaging position, a relative movement between the log and the first and second cutting heads 104, 106 in a direction along the longitudinal axis of the log, causes the first and second cutting heads 104, 106 to cut away respective sides of the log, at least along a portion of the length of the log. In FIG. 2, first cutting head 104 cuts a first side of the log, and second cutting head 106 cuts a second side of the log that is opposite to the first side.

In a specific example of implementation, the first and second cutting heads 104, 106 of the log-processing machine are stationary and it is the log that moves in a direction along its longitudinal axis. However in an alternate example of implementation, the log is held stationary and it is the cutting heads 104, 106 that move along the log in a direction parallel to the longitudinal axis of the log.

The log-processing machine 100 includes a drive unit (not shown) that imparts the relative movement between the log and the first and second cutting heads 104, 106. In a specific example of implementation, the drive unit can be a conveyor belt that is formed as part of the log-supporting device 108. In this manner, the log-supporting device 108 not only supports the log, but also feeds the log through the log-processing machine 100 in a direction along the longitudinal axis of the log. In other non-limiting examples of implementation, the drive unit can include a press roll or a chain.

As shown in FIG. 1, log-supporting device 108 is attached to the frame 102 via nuts and bolts 112. In this manner, the height of the log-supporting device 108 can be adjusted in relation to the frame.

In a specific example of implementation, first cutting head 104 and second cutting head 106 are canter chipper heads that are capable of forming pieces of lumber having substantially flat surfaces. The canter chipper heads also form high-quality wood chips as a byproduct. As shown in FIG. 1, canter chipper heads generally have a frusto-conical shape defining a front face 116 and a conical cutting surface 118. It should, however, be understood that different types of cutting heads can be used without departing from the spirit of the invention.

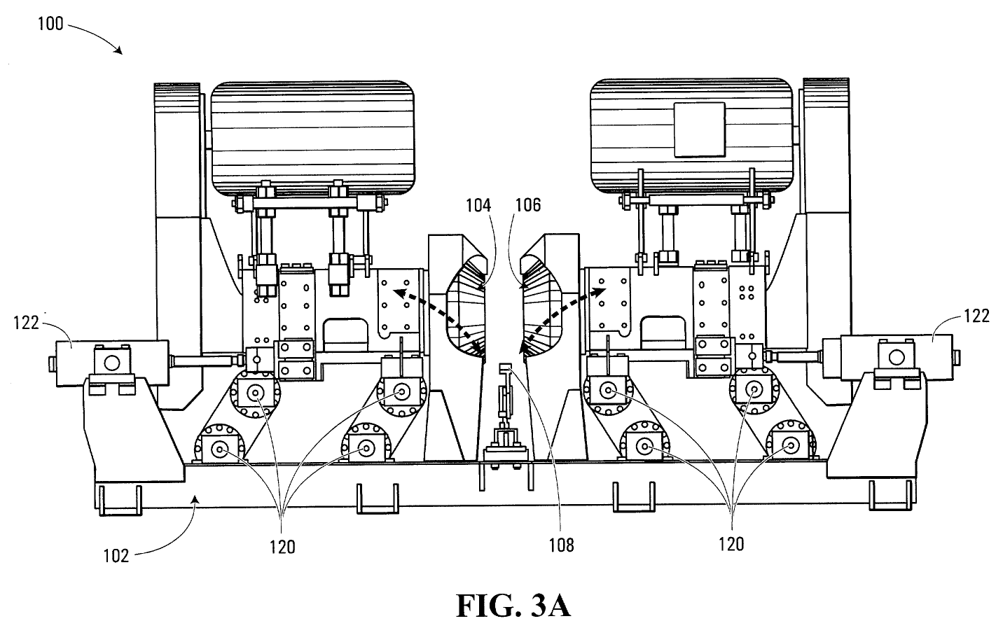

As mentioned above, the first and second cutting heads 104 and 106 of the present invention are movable in relation to the frame 102 along a path of travel that defines a plurality of log-engaging positions. As shown in FIGS. 3a and 3b, first cutting head 104 and second cutting head 106 are each mounted to frame 102 via at least one pivot 120. In the specific embodiment shown in FIGS. 3a and 3b, each of the first and second cutting heads 104 and 106 is mounted to frame 102 via four pivots 120, which form a parallel ruler linkage. As used herein, the term “parallel ruler linkage” refers to a linkage wherein a line drawn between two neighboring pivots 120 will always be parallel to a line drawn between the two opposing pivots 120, regardless of the movement of the linkage. As such, each of the first and second cutting heads 104, 106 is movable about the pivots 120 along an arcuate path of travel towards and away from a log. For the purposes of this description, the term “arcuate” means a curved path of any type. In the specific example shown, the arcuate paths of travel along which the first and second cutting heads 104, 106 move, is shown in dotted lines.

In a specific example of implementation, pivots 120 are formed from conical bearings (not shown), however any other type of bearing, or other device suitable for forming pivots 120 can be used without departing from the spirit of the invention. In addition, log processing machine 100, uses grease to lubricate the bearings of the pivots 120, so as to make sure the bearings function smoothly. As shown in FIGS. 3a and 3b, the grease is located in a watertight cage, which helps to maintain the machine clean and easy to maintain. Alternatively, the moving parts of the log-processing machine 100 can be lubricated using oil or any other lubricating substance known in the art.

In a specific example of implementation, the first and second cutting heads 104, 106 are pre-loaded. The cutting heads may be preloaded using any technique in the art, such as through springs, for example. The preloading of the cutting heads acts to eliminate the amount of vibration experienced by the first and second cutting heads 104, 106 during use. Advantageously, with the vibration greatly reduced, the log-processing machine is able to create a higher quality surface finish on the piece of lumber.

Log-processing machine 100 further includes two drive mechanisms 122 for moving the first and second cutting heads 104, 106 respectively, along their paths of travel. In a specific example of implementation, drive mechanisms 122 are operative for displacing the first and second cutting heads 104, 106 along their paths of travel in unison, but in opposite directions towards and away from a log. More specifically, the drive mechanisms 122 displace the first and second cutting heads 104, 106 such that they remain at identical distances to the log during at least a portion of their displacement. Alternatively, the drive mechanisms 122 are operative to move the first and second cutting heads independently of one another, meaning at different times and in any direction along the path of travel.

In the specific embodiment shown, the drive mechanisms 122 are electrical actuators. However in an alternative embodiment, the drive mechanisms 122 could be pneumatic or hydraulic cylinders. Additionally, any other type of drive mechanism 122 known in the art can be used for the purposes of moving the first and second cutting heads 104, 106 along their paths of travel. For example, motors located at pivots 120 for imparting rotational movement can also be used for the purposes of the present invention.

By enabling the first and second cutting heads 104, 106 to move about at least one pivot which defines a path of travel having both a vertical displacement component and a horizontal displacement component, the log-processing machine is better able to position a log in relation to the cutting heads. Advantageously, by better positioning a log in relation to the cutting heads, the log-processing machine 100 is able to create a higher quality surface finish on the log and better quality wood chips.

Referring back to FIG. 3a, the first and second cutting heads 104, 106, are shown in a first log-engaging position along their respective paths of travel. In this specific log-engaging position, the first and second cutting heads 104, 106 are positioned close together and in a relatively low position in relation to the log supporting device 108. As will be described further on in the description, this first log-engaging position is suitable for processing logs having a small diameter. FIG. 3b shows the first and second cutting heads 104 and 106 in a second log-engaging position along their respective paths of travel, wherein the first and second cutting heads 104, 106 are positioned farther apart and higher up in relation to the log supporting device 108 (assuming that the height of the log supporting device has not been altered). This second position is suitable for processing logs having a larger diameter. Although FIGS. 3a and 3b show only two log-engaging positions, it should be understood that the arcuate path of travel defines a multitude of log-engaging positions. The specific log-engaging position selected by the operator of the log-processing machine 100 will be dependent on the depth of the cut desired, and the size of the log being processed.

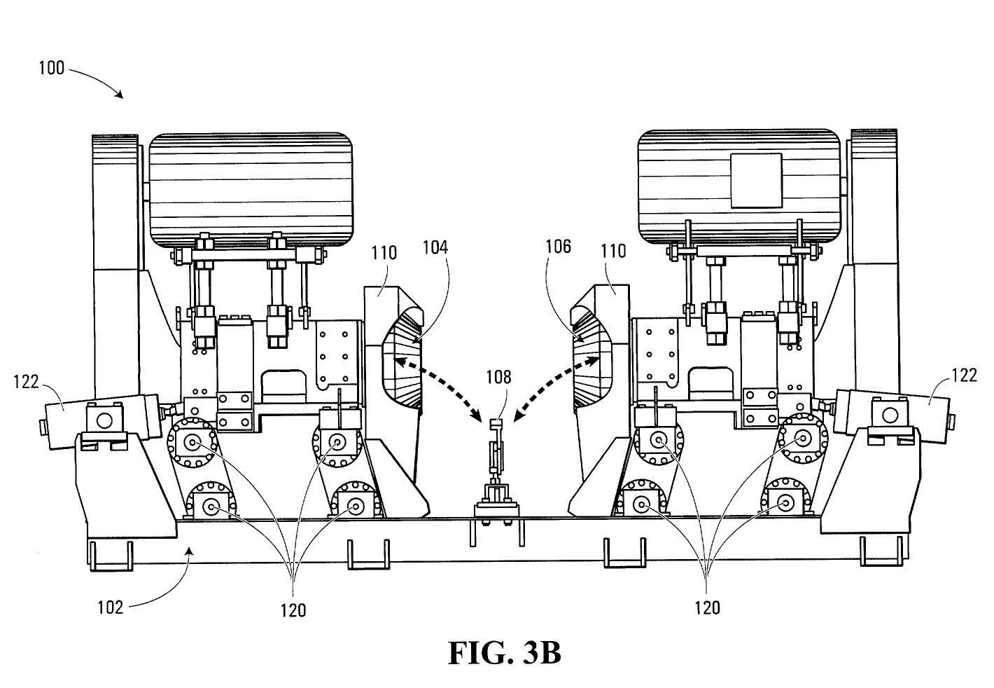

Shown in FIGS. 4a and 4b are first and second cutting heads 400, 402, in accordance with a log-processing machine of the prior art. First and second cutting heads 400, 402 are movable along a path of travel having only one direction, namely a horizontal component, such that although the path of travel defines a plurality of log-engaging positions, the first and second cutting heads are unable to move in a vertical direction. This vertical path of travel in indicated by dotted lines 408. FIG. 4a shows first and second cutting heads 400, 402, in a first log engaging position suitable for receiving a log having a small diameter. FIG. 4b shows first and second cutting heads 400, 402 in a second log engaging position suitable for receiving a log having a large diameter. In the second log engaging position, since the cutting heads are unable to move in the vertical direction, when the upper limit 406 of the front face meets the outer diameter of the log, there is a large distance between the bottom limit 404 of the front face and the intersection of the outer diameter of the log. This distance is represented by dimension “x”.

It has been found in the industry that the smaller the distance between the bottom limit 404 of the front face and the intersection of the cutting head with the outer diameter of the log, the better is the quality of the wood chips and the surface finish of the lumber.

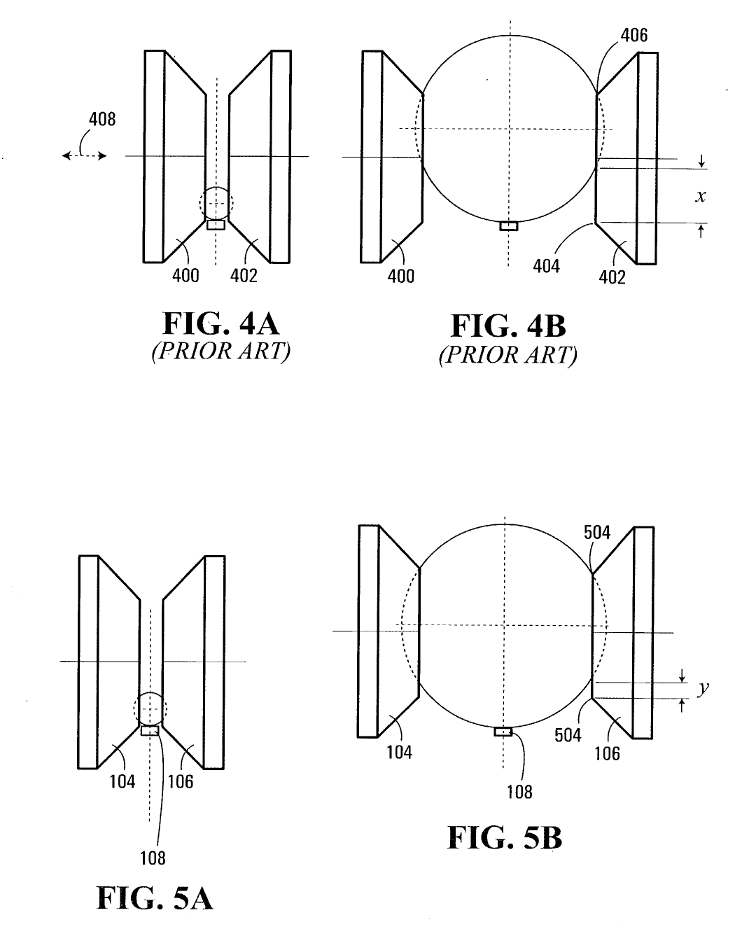

Shown in FIGS. 5a and 5b are close up views of the first and second cutting heads 104 and 106 in two log-engaging positions. FIG. 5a shows first and second cutting heads 104 and 106 in the first log engaging position (shown in a larger view in FIG. 3a) which is suitable for processing logs having small diameters. FIG. 5b shows first and second cutting heads 104, 106 in a second log engaging position suitable for receiving logs having large diameters. Since the cutting heads of the present invention are movable about a path of travel having both a horizontal displacement component and a vertical displacement component, the first and second cutting heads 104, 106 are able to move both horizontally and vertically, in order to both widen the distance between the two cutting heads, and better position the central axis of the log in relation to the central axis of the first and second cutting heads 104, 106. This means that when the upper limit 502 of the front face 116 meets the outer diameter of the log, there is a much smaller distance between the bottom limit 504 of the front face 116 and its intersection with the outer diameter of the log. This distance is indicated by the dimension “y”.

Ideally, there would be no distance “y” between the bottom limit 504 and the intersection of the front face 116 with the outer diameter of the log. The smaller the distance “y”, then the better is the surface finish of the log. Therefore, the above described movement of the first and second cutting heads 104, 106 enables an operator of the log-processing machine 100 to better position a log between the first and second cutting heads 104, 106 without having to adjust the height of the log-supporting device 108.

In the above description, the log-processing machine 100 has been described as having two cutting heads, namely a first cutting head 104 and a second cutting head 106, however, it should be understood that it is within the scope of the present invention for a log-processing machine 100 to have only one cutting head. In such cases the log-processing machine would function in exactly the same manner as the log-processing machine 100 as described above, only the frame 102 or the log supporting device 108 of the log-processing machine 100 would be operative to maintain the log in position against the single cutting head, such that the single cutting head is able to evenly cut away one side of the log. For example, the frame could include a side wall positioned parallel to the front face 116 of the single cutting head, in order to prevent the log from moving in a direction perpendicular to its longitudinal axis as it is being cut.

It should also be understood that in the cases where the log-processing machine 100 includes only a single cutting head, the movement of the single cutting head along the pivotal path of travel is identical to the movement of the first and second cutting heads 104, 106 along their paths of travel as described above. In other words, the single cutting head moves about at least one pivot through a path of travel that includes both a horizontal displacement component and a vertical displacement component.

Although various embodiments have been illustrated, this was for the purpose of describing, but not limiting, the invention. Various modifications will become apparent to those skilled in the art and are within the scope of this invention, which is defined more particularly by the attached claims.

1) A log-processing machine, comprising:
a) a frame;
b) a cutting head mounted to said frame via at least one pivot, said cutting head being movable about said pivot toward a log, whereby when said cutting head engages the log, a relative movement between the log and said cutting head in a longitudinal direction of the log causes said cutting head to cut away a side of the log at least along a portion of the length of the log.

2) A log-processing machine as defined in claim 1, wherein said cutting head is movable about the pivot between a plurality of log-engaging positions.

3) A log-processing machine as defined in claim 1, wherein said cutting head is a chipper head.

4) A log-processing machine as defined in claim 3, including a drive unit to impart the relative movement between said cutting head and the log in the longitudinal direction of the log.

5) A log-processing machine as defined in claim 4, wherein said drive unit is capable of receiving the log and displacing the log in the longitudinal direction of the log with relation to said cutting head.

6) A log-processing machine as defined in claim 1, wherein said cutting head is a first cutting head, said at least one pivot is a first pivot, said log-processing machine including a second cutting head mounted to said frame via at least one second pivot, said second cutting head being mounted opposite said first cutting head and being movable about said second pivot toward a log, whereby a relative movement between the log and said second cutting head in the longitudinal direction of the log causes said second cutting head to cut away a side of the log opposite the side of the log cut by said first cutting head.

7) A log-processing machine as defined in claim 6, wherein each of said first and second cutting heads are mounted to said frame via a parallel ruler linkage.

8) A log-processing machine as defined in claim 6, including a head drive mechanism for displacing said first cutting head and said second cutting head in unison but in opposite directions towards and away from each other.

9) A log-processing machine as defined in claim 8, wherein said drive mechanism displaces said first cutting head and said second cutting head such that said first cutting head and said second cutting head remain at identical distances to the log during at least a portion of the displacement towards and away from the log.

10) A log-processing machine as defined in claim 7, wherein said parallel ruler linkage includes conical bearings.
